(19) United States
(12) Patent Application Publication
(10) Pub. No.: US 2002/0096125 A1
(43) Pub. Date: Jul. 25, 2002

(54) Hair grooming device having ionizer and an ultrasonic wave generator

(75) Inventor: William Wing Hai Fong, Hong Kong (HK)

Correspondence Address: RICHARD K. WARTHER, ALLEN, DYER,DOPPELT,MILBRATH & GILCHRIST P.A., 1401 CITRUS CENTER 255 SOUTH ORANGE AVENUE, P.O. BOX 3791, ORLANDO, FL, 32802-3791, US

(73) Assignee: Lentek International, Inc., Orlando, FL

(21) Appl. No.: 09/920,447

(22) Filed: Aug. 1, 2001

Related U.S. Application Data
(60) Provisional application No. 60/223,678, filed on Aug. 8, 2000.

(51) Int. Cl. A01K 29/00

(52) U.S. Cl. 119/664

(57) ABSTRACT

A hair grooming device includes a casing having a handle section adapted to be grasped by hand and a hair engaging section and respective planar attachment surface on which hair grooming tools are attached. A voltage generator is contained within the casing. An electrode assembly is mounted within the hair engaging section and operatively connected to the voltage generator for generating ionized and ionized air onto hair to be groomed. An ultrasonic wave generator is mounted within the hair engaging section and operatively connected to the voltage generator for generating ultrasonic waves onto hair for repelling fleas.

### RELATED APPLICATION

This application is based upon prior filed copending provisional application Ser. No. 60/223,678 filed Aug. 8, 2000.

### FIELD OF THE INVENTION

This invention relates to grooming aids for hair, such as for pets, and more particularly, this invention relates to a hair grooming device that emits oxidized and ionized air.

### BACKGROUND OF THE INVENTION

Hair grooming aids have been used for thousands of years. Typically, they include a body having a handle section and hair engaging section or brush head with brushes, bristles or other means for grooming hair, such as that belonging to a pet. Currently, more advanced hair grooming devices using electrostatic precipitators, such as disclosed in U.S. Pat. No. 5,975,090 to Taylor et al., and U.S. Pat. No. 4,632,135 to Lenting et al., have become more commonplace. In those type of hair brushes using electrostatic precipitators, a high voltage source is enclosed within the hair grooming device or brush and generates a high voltage to an array of electrodes. Ions or oxidized air are generated by the electrodes through at least one air vent or slot onto any hair that is being groomed.

Although these type of grooming brushes produce ozone and ions to kill germs and bacteria, and are sometimes efficient enough to act as a deodorizer, they typically use an array of electrodes with complicated wire arrangements, fans or other apparatus. Even though small bacteria may be killed when using such a device, there is typically no mechanism for repelling fleas with that type of brush.

### SUMMARY OF THE INVENTION

The present invention is advantageous and provides a hair grooming device, such as a grooming brush, that generates oxidized and ionized air onto hair to be groomed for killing many types of germs and bacteria that could be present on hair and scalp, while deodorizing the hair and scalp, and additionally, provides for ultrasonic wave generation onto hair and scalp for repelling fleas.

In accordance with one aspect of the present invention, the hair grooming device includes a casing having a handle section adapted to be grasped by hand. A hair engaging section includes a respective planar attachment surface on which hair grooming tools are attached. A voltage generator is contained within the casing. An electrode assembly is mounted within the hair engaging section and operatively connected to the voltage generator for generating iodized and ionized air onto hair to be groomed. An ultrasonic wave generator is mounted within the hair engaging section and operatively connected to the voltage generator for generating ultrasonic waves onto hair for repelling fleas.

In yet another aspect of the present invention, the electrode assembly comprises a substantially annular configured electrode member and an electrode extension member spaced from and spaced centrally of the annular configured electrode member. The annular configured electrode member can be formed as a polygon, such as an n-sided polygon member. A non-limiting example includes an annular configured electrode member that has five to nine sides. The electrode extension member, in yet another aspect of the present invention, is a tapered electrode member formed as a triangular extension member having an electrode point that is spaced centrally of and in a plane defined by the annular configured electrode member.

In another aspect of the present invention, the ultrasonic wave generator comprises at least one ultrasonic transducer mounted at the hair engaging section to emit ultrasonic waves. The ultrasonic transducer can comprise a planar disc-shaped transducer mounted at the hair engaging section and adjacent the respective planar attachment surface. At least one air vent is formed therein to allow ionized and oxidized air to be emitted. At least one vent is formed within the hair engaging section to allow ultrasonic waves to pass. The casing includes a battery attachment for holding a battery that connects to the voltage generator.

In yet another aspect of the present invention, the voltage generator can generate as high as about 6,500 to about 7,500 volts DC to the electrode assembly. The current can be about 16 microampere. An ultrasonic voltage circuit can be connected to the high voltage generating circuit to provide proper voltage and current to any ultrasonic transducers chosen by those skilled in the art.

### BRIEF DESCRIPTION OF THE DRAWINGS

Other objects, features and advantages of the present invention will become apparent from the detailed description of the invention which follows, when considered in light of the accompanying drawings in which:

FIG. 1 is an isometric view of the hair grooming device of the present invention.

FIG. 2 is a plan view of the hair grooming device shown in FIG. 1.

FIG. 3 is a plan view of the hair grooming device showing the hair engaging section as a brush head and respective planar attachment surface on which support plates containing hair grooming tools are attached.

FIGS. 4 and 5 are respective right and left side elevation views of the hair grooming device without the attached hair grooming tools.

FIG. 6 is a plan view of the hair grooming device of the present invention showing the attached hair grooming tool with solid bristles.

FIGS. 7 and 8 are respective left and front side elevation views showing the hair grooming device of the present invention with an attached hair grooming tool having brushes.

FIGS. 9 and 10 are respective left and front side elevation views showing the hair grooming device of the present invention having the attached hair grooming tool using a serrated edge.

FIG. 11 is a plan view of the hair grooming device shown in FIGS. 9 and 10.

FIGS. 12 and 13 are respective left and front side elevation views of the hair grooming device of the present invention having an attached hair grooming tool using straight wires.

FIG. 14 is a plan view of the interior of the bottom casing member showing the ultrasonic transducers mounted therein.

FIG. 15 is a plan view similar to FIG. 14, but showing one of the ultrasonic transducers removed from its mounted location and showing vents as orifices to allow ultrasonic waves to pass through the bottom casing member.

FIG. 16 is a block diagram of a representative circuit that could be used with the present invention for driving the ultrasonic transducer and electrode assembly.

FIG. 17 is a fragmentary diagram of a representative electrode assembly of the present invention.

FIG. 18 is a plan view of the upper casing member showing a printed circuit board having the voltage generator and a portion of the electrode assembly secured thereto.

FIG. 19 is an isometric view of the upper casing member shown in FIG. 18, and showing the printed circuit board removed therefrom and showing in greater detail the electrode assembly having the electrode extension member and annular configured electrode member.

FIGS. 20-22 are fragmentary drawings showing the operation and production of positive and negative ions and super oxygenated molecules as ozone during operation of the hair grooming device of the present invention.

### DETAILED DESCRIPTION OF THE PREFERRED EMBODIMENTS

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

The present invention is advantageous and provides an improved hair grooming device, such as a grooming brush that is advantageous over many prior art devices that generate ionized air and ozone onto hair and scalp for bacteria control. The present invention is advantageous because it not only provides a hair grooming device with an electrode assembly mounted within a brush head and operatively connected to a voltage generator for generating iodized and ionized air onto hair to be groomed, but also provides an ultrasonic wave generator mounted within the brush head and operatively connected to the voltage generator for generating ultrasonic waves onto hair for repelling fleas. In various embodiments, the electrode assembly can be used in conjunction with the ultrasonic wave generator or the electrode assembly can be used without the ultrasonic wave generator. In still other embodiments, the hair grooming device can include only the ultrasonic wave generator without the electrode assembly.

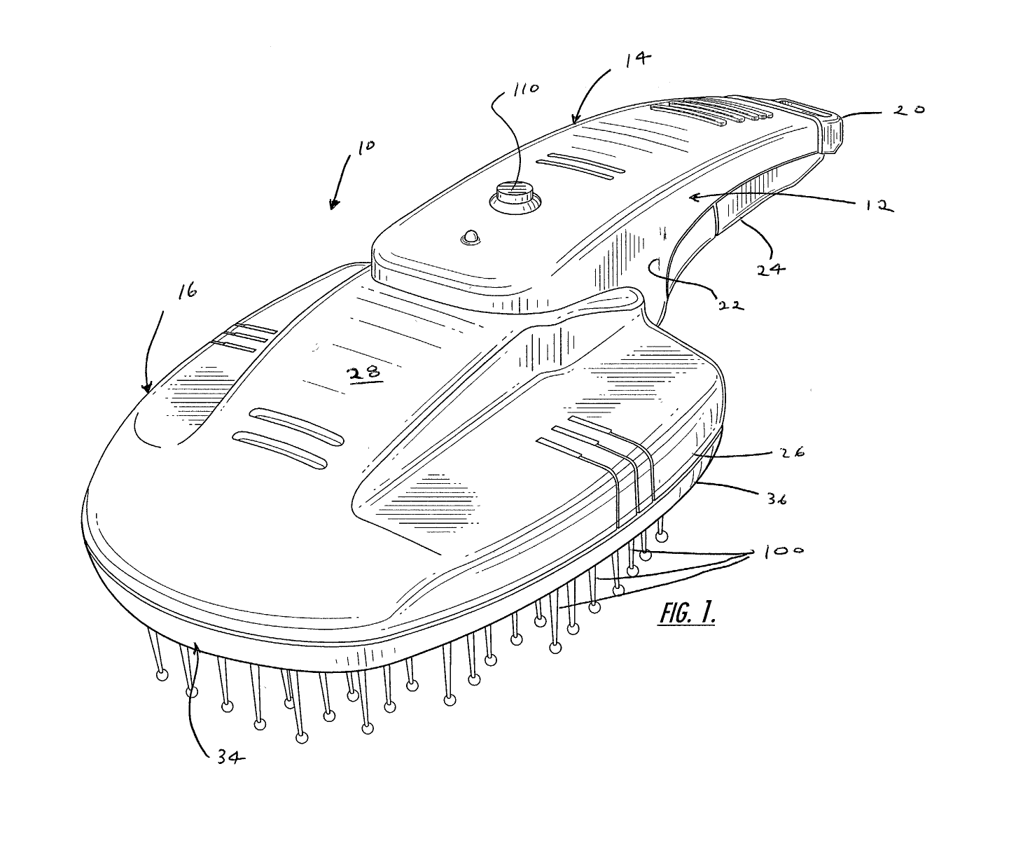

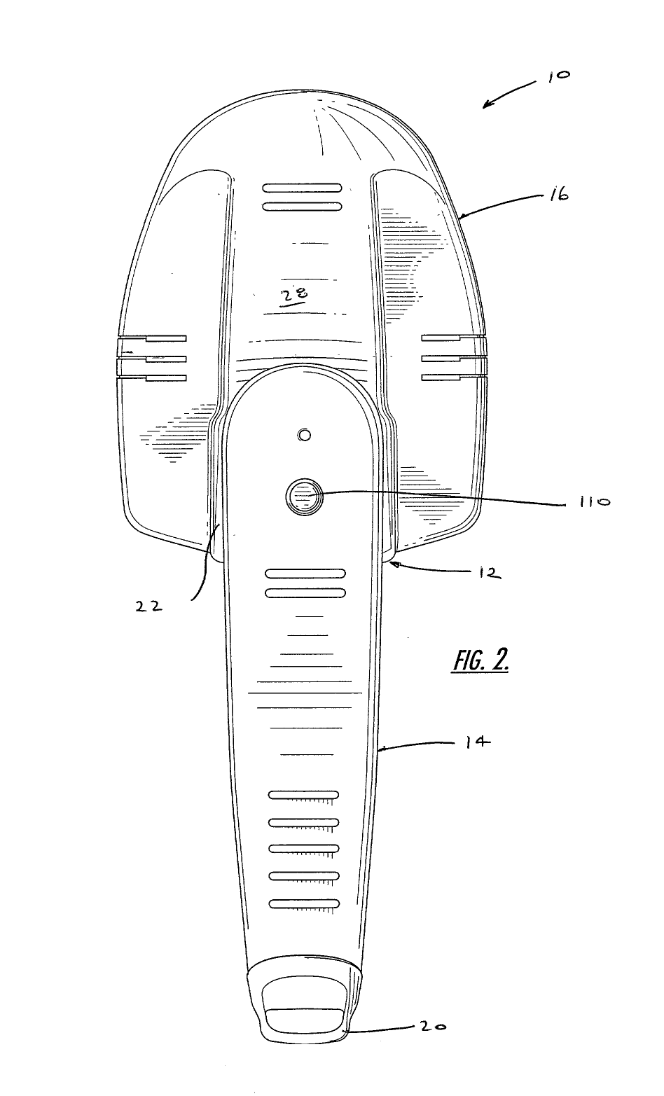

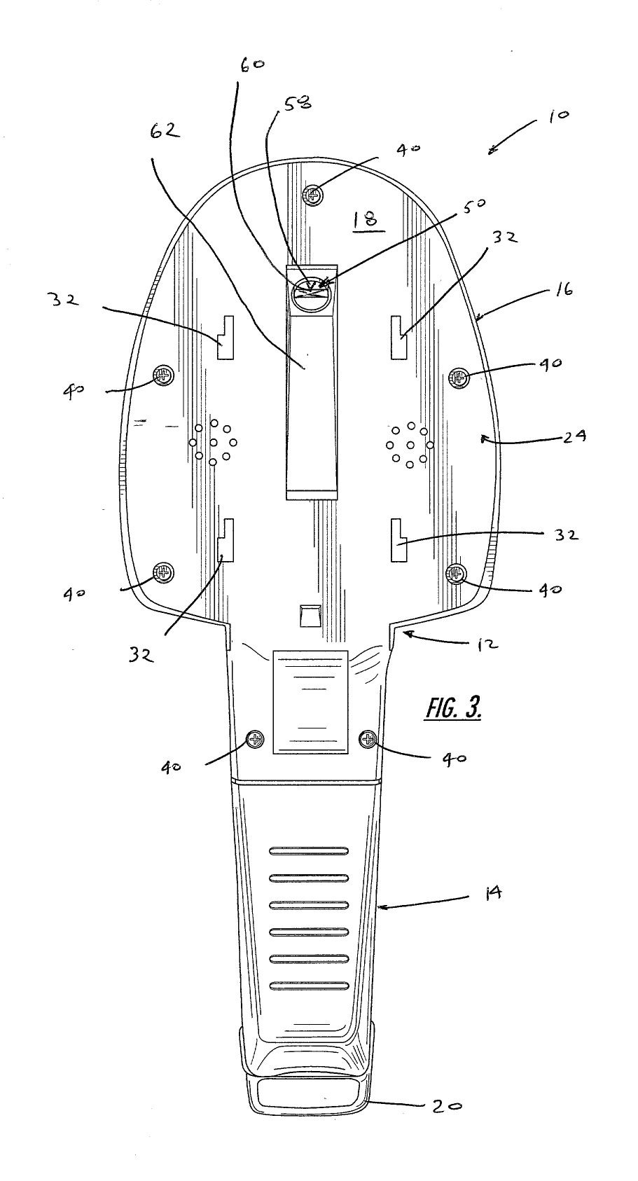

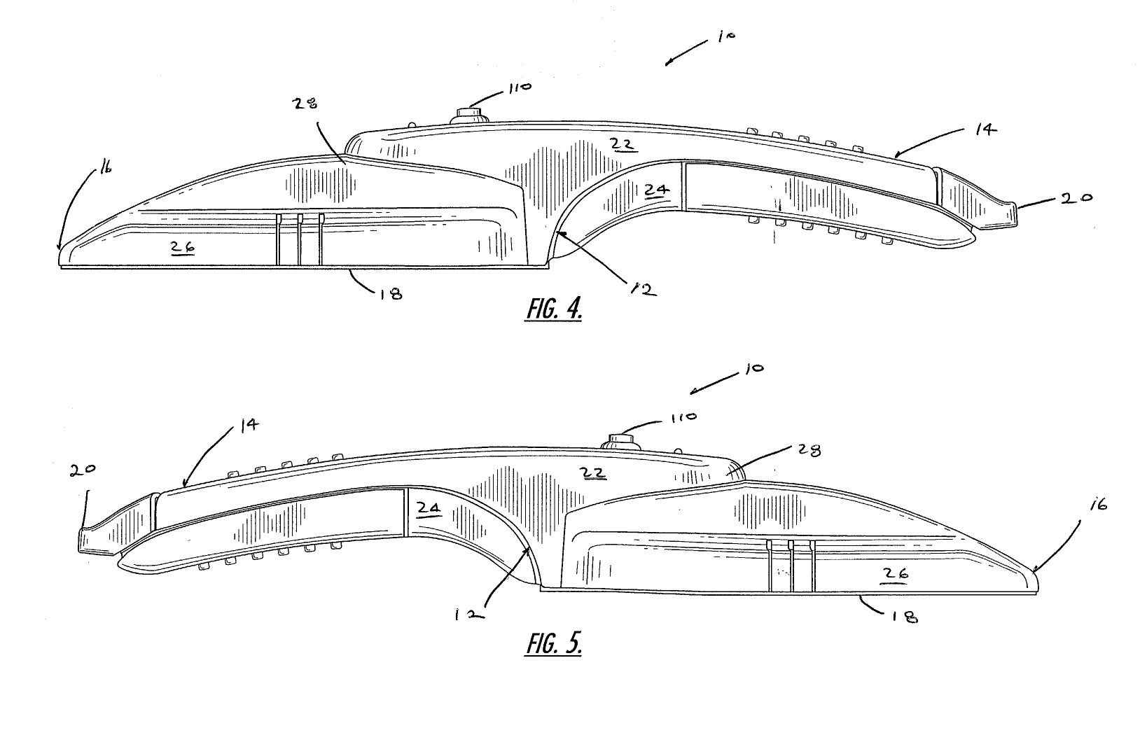

FIGS. 1-6 illustrate various views of the hair grooming device 10 of the present invention. The device 10 includes a casing 12 having a handle section 14 adapted to be grasped by hand and a hair engaging section, i.e., brush head 16, which includes a respective planar attachment surface 18 (FIGS. 3-5) on which hair grooming tools are attached. The handle section 14 extends rearward from the hair engaging section 16 that is formed wider than the handle section 14, thus forming a wider area of contact for engaging hair and scalp. The handle section 14 includes a formed hanger 20 that allows the hair grooming device to rest on a hanger, hook, or other means.

The casing 12 is formed from a respective upper and lower casing member 22,24. The casing members 22,24 can be formed from plastic injection molded parts or similar formed parts and materials as suggested to those skilled in the art.

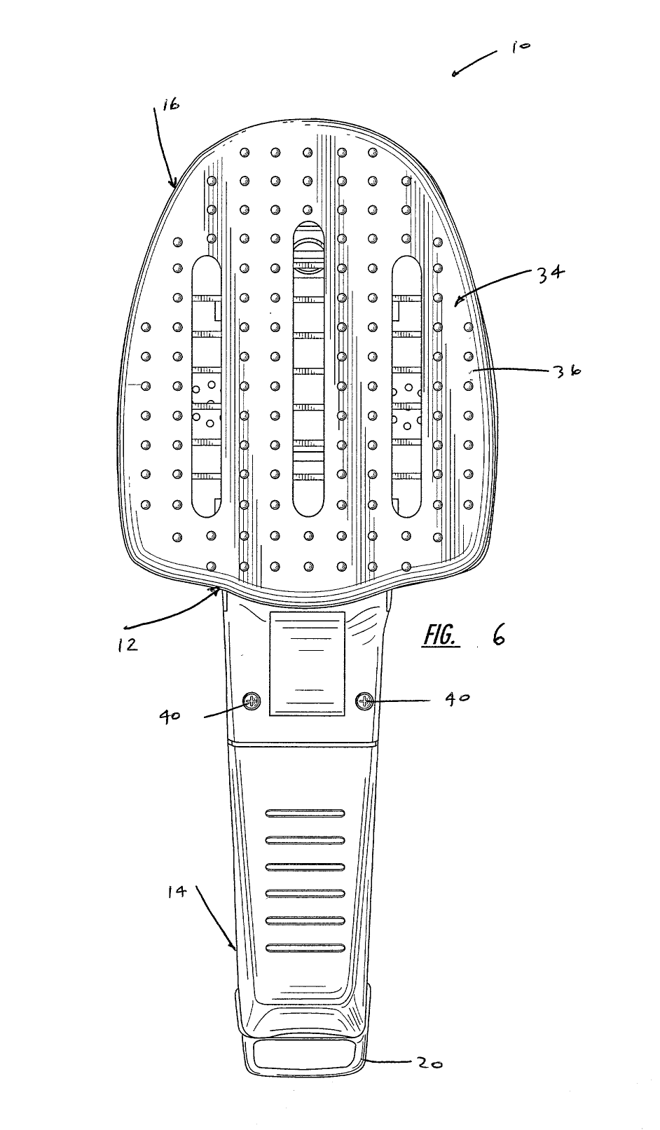

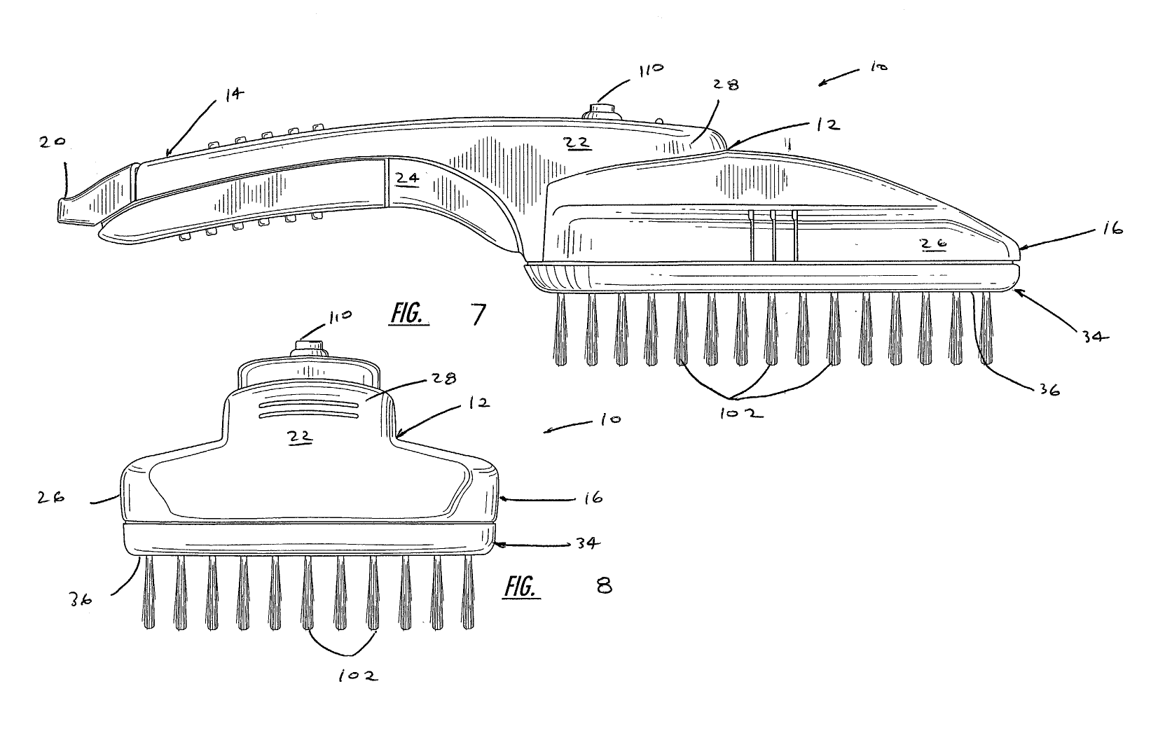

The upper casing member 22 includes the formed hanger 20 and forms a top covering section that extends over the lower casing member 24. The upper casing member 22 includes side edges 26 at the hair engaging section 16 and a central, enlarged area 28 for containing a voltage generator and at least a portion of an electrode assembly as explained in greater detail below. The lower casing member 24 at the hair engaging section 16 includes the respective planar attachment surface 18 (FIG. 3) on which hair grooming tools are attached. Four grooming tool attachment slots 32 are formed in the planar attachment surface 18 and allow attachment of various hair grooming tools 34, such as the illustrated brushes of FIGS. 7 and 8, or thick bristles of FIG. 1. Hair grooming tools 34 are attached to a support plate 36 having respective attachment legs that fit within the attachment slots 32. The lower casing member 24 is typically secured to the upper casing member 22 by attachment members 40 such as screws, as shown in FIG. 3.

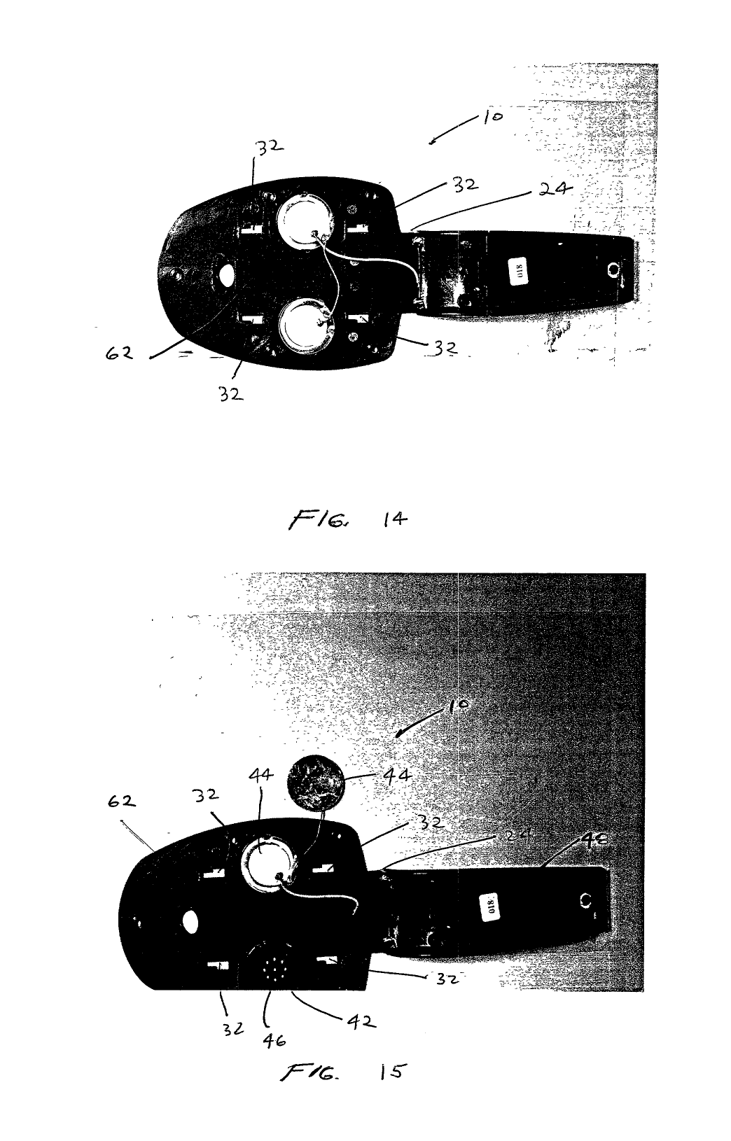

Referring now to FIGS. 14-19, details of the voltage generator, electrode assembly and ultrasonic wave generator are shown in detail. As shown in FIGS. 14 and 15, the lower casing member 24 includes on its interior surface two cylindrically formed transducer mounting sections 42 in which planar configured, e.g., planar and disc shaped ultrasonic transducers 44, are mounted on respective sides of the lower casing member. At the point where the transducers are mounted, an ultrasonic wave air vent 46 in the form of multiple orifices are formed to allow any ultrasonic waves generated by the ultrasonic transducers to pass therethrough (FIG. 15).

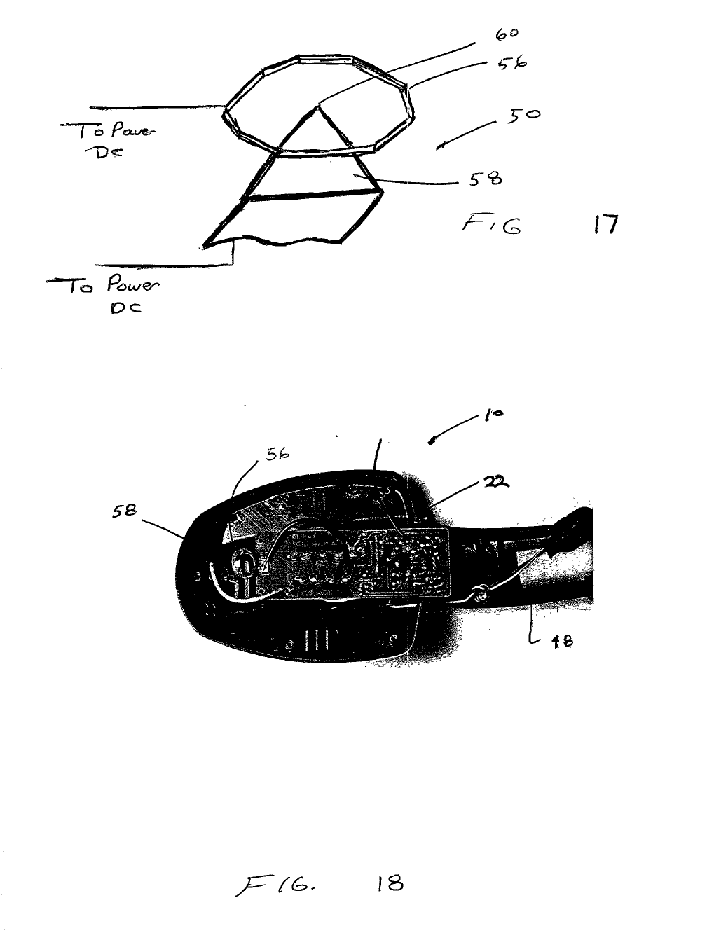

The handle section 14 of the lower casing member 24 includes a battery storage area that is formed together with the upper casing member and forms a battery compartment 48 for holding a battery. As illustrated, a nine volt battery can be stored in the handle section 14 of the casing, as shown in FIG. 18, showing a foam support on which the nine volt battery rests.

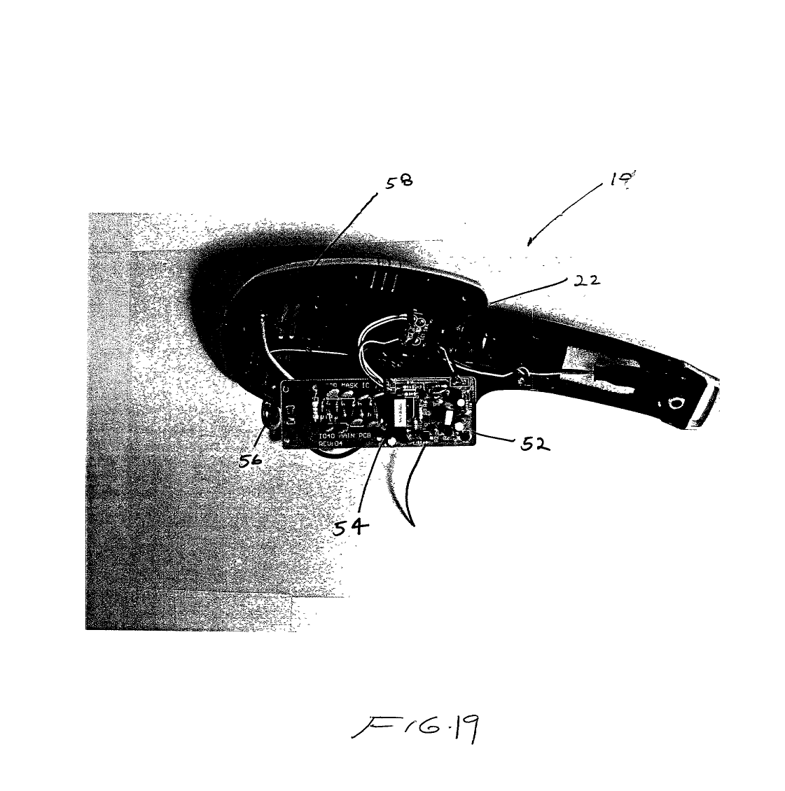

The area positioned between the two ultrasonic transducers 44 allows the electrode assembly 50 of the present invention to be positioned. The upper casing member 22, as shown in FIGS. 18 and 19, includes the enlarged central portion 28 which supports a printed circuit board 52 having transformer, transistor and diode and related circuit components forming a voltage generator 54. As illustrated in the specific embodiment illustrated in FIGS. 18 and 19, the electrode assembly 50 includes an annular configured electrode member 56 (FIG. 17) that is secured onto the printed circuit board 52 as a support surface. An electrode extension member 58 is spaced from and spaced centrally of the annular configured electrode member, as shown in FIG. 17, and is mounted in one aspect of the present invention on the interior surface of the upper casing member 22, as shown in FIG. 19. This electrode extension member 58, in one aspect of the present invention, is formed as a triangular configured extension member with an electrode point 60 such that when the circuit board 52 is mounted in the upper casing member 22 and appropriate components wired, the electrode point 60 extends substantially coplanar with the annular configured electrode member.

The annular configured electrode member 56 can also be formed as a polygon with n-sides, as shown in FIG. 17, where the polygon is a nine-sided polygon, but could vary as a six-sided polygon or any number of N-sides. In one non-limiting example, a five-sided polygon has been used to form a pentagon shaped annular electrode. The printed circuit board 52 includes appropriate circuit components, including the transistors, diodes, resistor ladder, capacitor circuits and appropriate transformer and electronic circuits for providing a high voltage energy source for the electrode assembly and allow sufficient ion production and ozone production.

As illustrated in FIG. 3, a central slot 62 is formed in the area between where the ultrasonic transducers 44 are located to form an ionized air channel where, at its end, the electrode assembly 50 is positioned in the present invention.

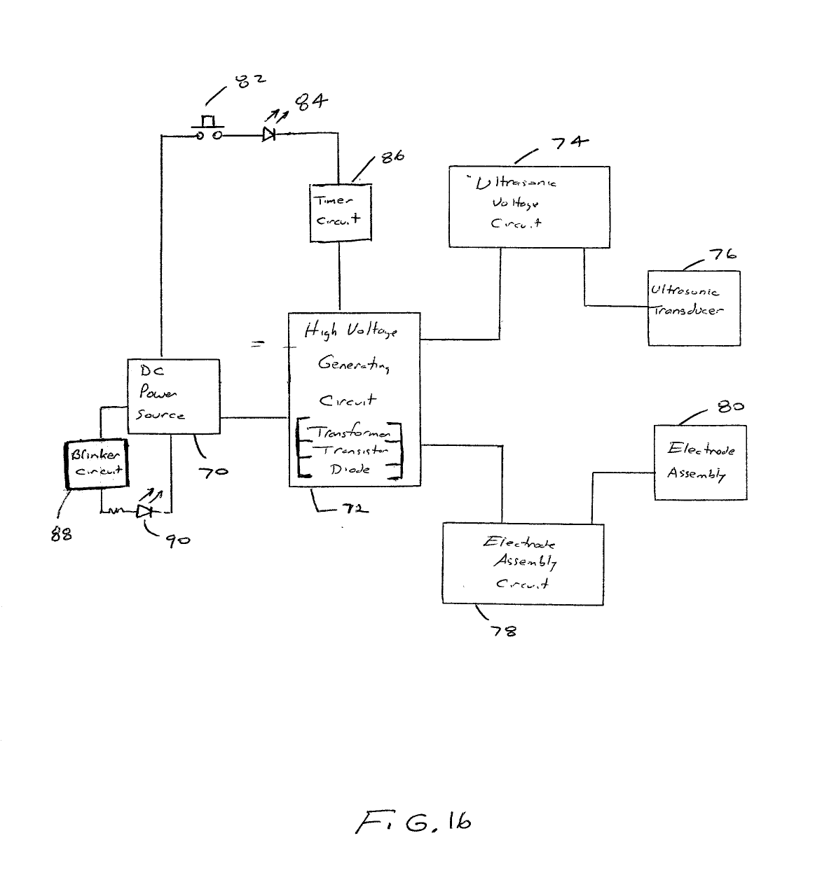

FIG. 16 illustrates a basic block diagram of a type of circuit that can be used with the present invention. Each described component is given a new reference numeral in this diagram for purposes of description. The DC power source 70 could be a nine volt battery or other power source, as known to those skilled in the art. The high voltage generating circuit 72 can be formed as transformer, transistor and diodes and is connected to the DC power source and typically mounted on a printed circuit board. Although it can vary in the output, typically about 6,500 to about 7,500 volts are produced with about 10 to about 20 microampere current. The ultrasonic voltage circuit 74 is typically a part of the high voltage generating circuit 72, but could be a separate circuit either on the printed circuit board or separate, and operatively connected to the ultrasonic transducers 76. The electrode assembly circuit 78 can be part of the high voltage generating circuit 72 or separate and positioned on the printed circuit board and connected to the electrode assembly 80 as described. A push button switch 82 allows on/off operation, and a light emitting diode 84 indicates a power-on status. A timer circuit 86 permits automatic circuit shut down after a predetermined period of time. A blinker circuit 88 is operative with a light emitting diode 90 to indicate a “low battery” condition.

Naturally, any number of different circuits and circuit components can be chosen for the present invention, as known to those skilled in the art. Representative examples of typical operating parameters that could be used with the present invention are set forth in Table I below:

TABLE I
Typical Operating Parameters

| | |
|---|---|
| Flow Rate: | 50-100 ft/sec (15-30 m) |
| Ion Output: | 100 trillion/sec |
| O₃ Output: | >1 ppm |
| Voltage In: | 9 v dc |
| Voltage Out: | 6,900 v |
| Current Out: | 16 uA |
| Coverage Area: | area where brushed |
| Unit Weight: | 0.433 lbs (0.1964 kg) |
| Unit Dimensions: | 9.8 × 2.5 × 3.6″ (24.9 × 6.4 × 9.2 cm) |

The various hair grooming tools 34 that can be attached to the casing 12 can vary. Each hair grooming tool typically includes a support plate 36 as described before with the attachment legs. FIGS. 1 and 6 show a hair grooming tool 34 with bristles 100 formed as tapering members with spherical scalp engaging balls at the end. FIGS. 7 and 8 show a hair grooming tool 34 with brushes 102 as is conventional in many hair grooming devices.

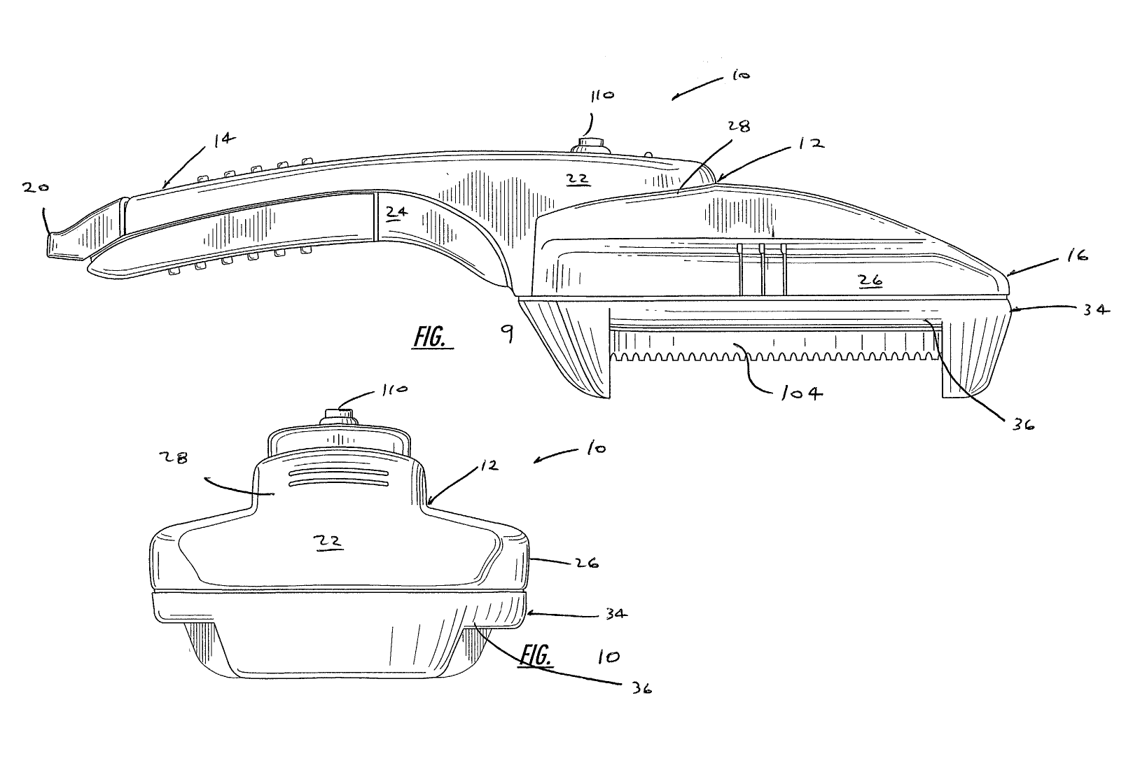

FIGS. 9-11 show an alternative hair grooming tool 34 with two concave metallic edges 104 that are serrated to engage thick and matted hair.

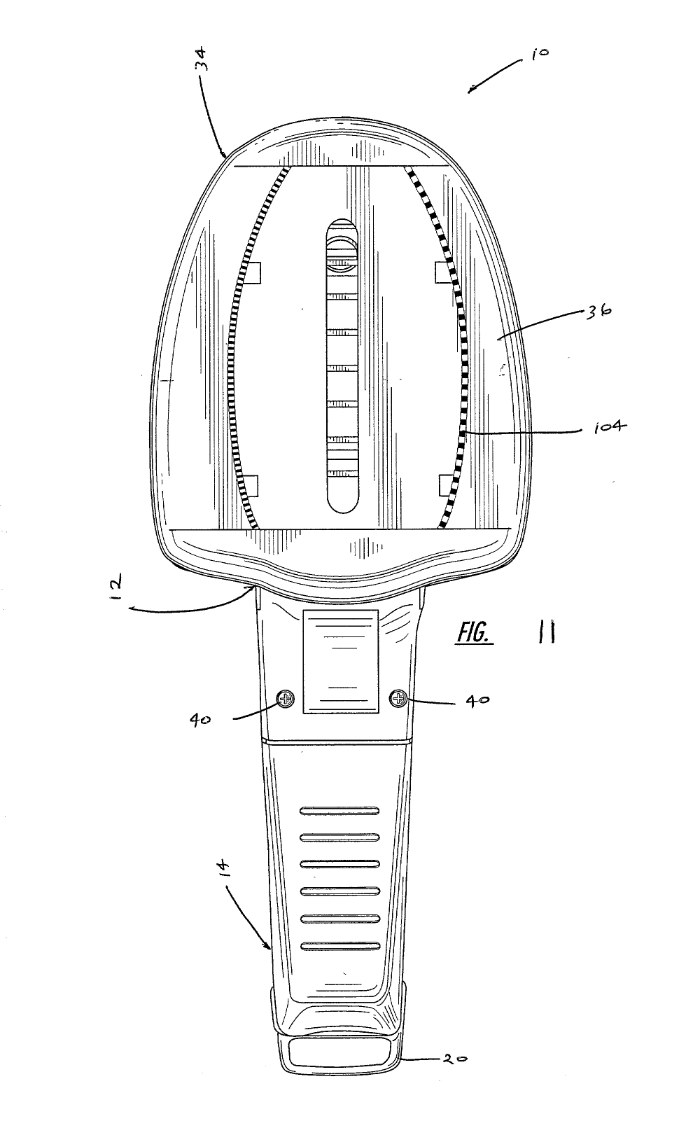

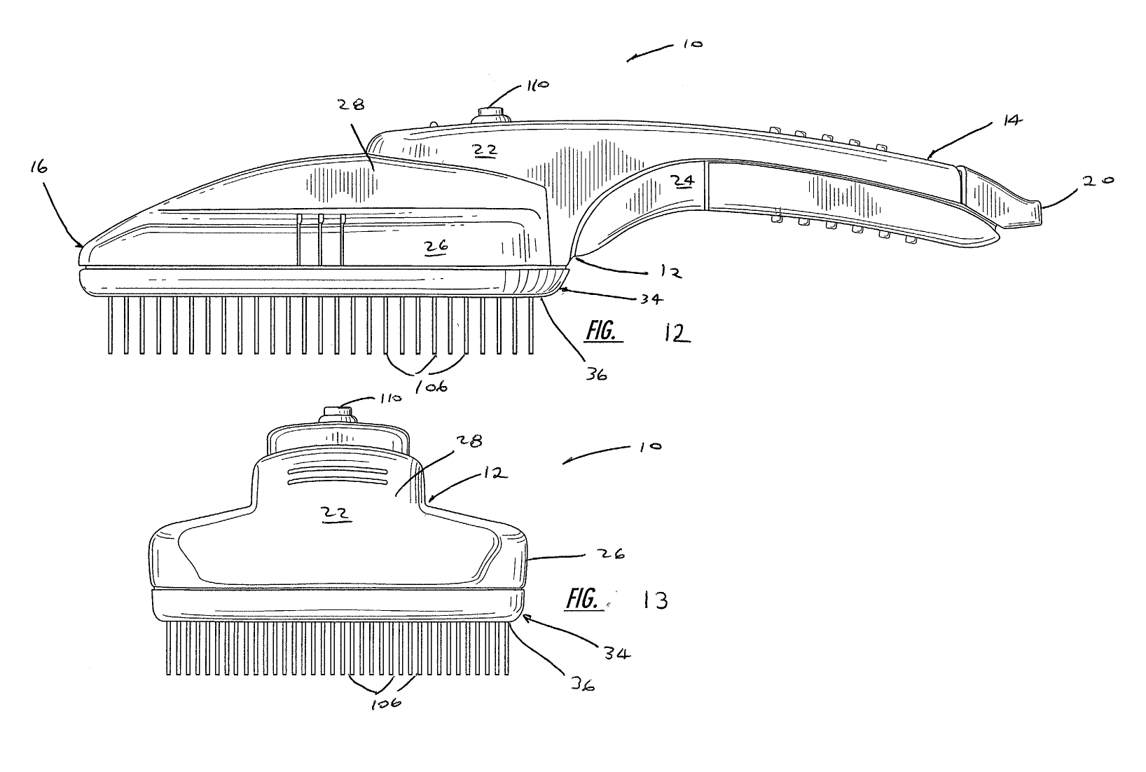

FIGS. 12 and 13 illustrate a hair grooming tool 34 with wires 106 formed as bristles. Depending on the type of hair to be groomed and the number of knots or fleas contained in the hair and scalp, the different hair grooming tools can be selected as desired. Other hair grooming tools can be used as suggested by those skilled in the art.

The circuit includes the on/off switch 82 in the form of a push button 110 as shown in FIG. 1. The circuit also includes the timer 86 to allow automatic shut off after five minutes of use. The LED 84 circuit can be a green LED to indicate that power is on, while a flashing red LED 90 indicator could indicate that the battery is low.

Up to 100 trillion super oxygenated molecules can be released every second, causing odors to break down and leave only fresh oxygen in its path. The ultrasonic transducers are typically set to a specific frequency that repels fleas, but harmless to a pet. Any negative ions that are introduced to pollutants, such as dust, smoke, soot and pollen allow a combination of molecules to drop to the ground, significantly reducing the number of present pollutants.

The hair grooming tools 34 include a support plate 36 with appropriate orifices that are operative with the ionized air vent and ultrasonic wave vent.

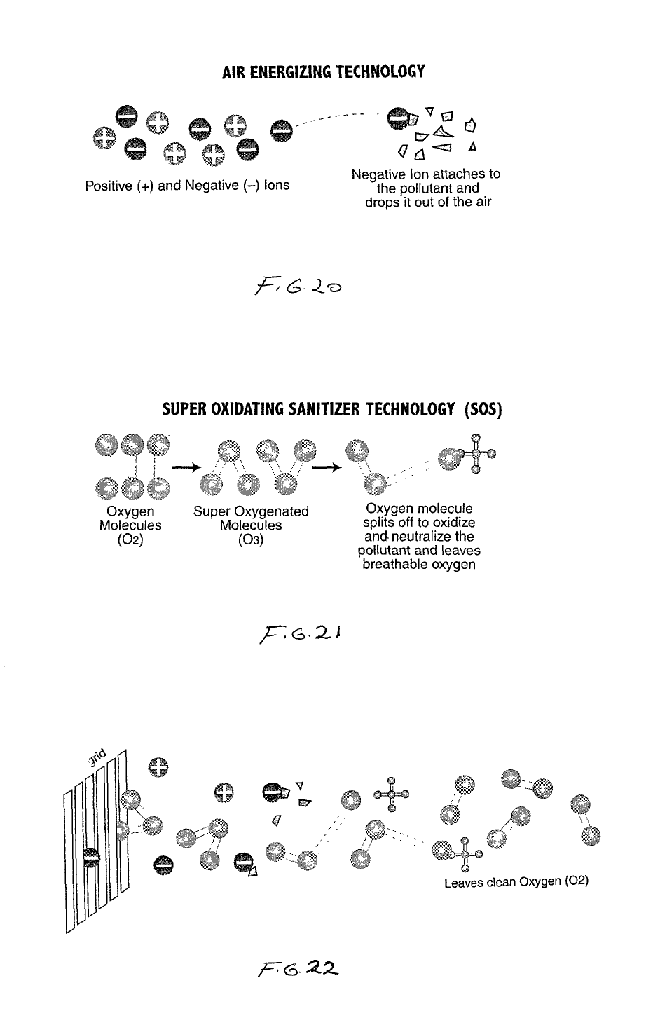

FIGS. 20-22 show the operation of the present invention where positive and negative ions are generated such that a negative ion attaches to the pollutant and drops it out of the air. As shown in FIG. 21, oxygen molecules can become super oxygenated as ozone molecules wherein an oxygen molecule can split off to oxidize and neutralize a pollutant and leave breathable oxygen, as shown in FIG. 22.

Many modifications and other embodiments of the invention will come to the mind of one skilled in the art having the benefit of the teachings presented in the foregoing descriptions and the associated drawings. Therefore, it is to be understood that the invention is not to be limited to the specific embodiments disclosed, and that the modifications and embodiments are intended to be included within the scope of the dependent claims.

That which is claimed is:

1. A hair grooming device comprising:
a casing having a hair engaging section;
a voltage generator contained within said casing; and
an ultrasonic wave generator mounted within said hair engaging section and operatively connected to said voltage generator for generating ultrasonic waves onto hair for repelling fleas.

2. A hair grooming device according to claim 1, and further comprising an electrode assembly mounted within said casing and operatively connected to said voltage generator for generating oxidized and ionized air onto hair to be groomed.

3. A hair grooming device according to claim 1, wherein said electrode assembly comprises a substantially annular configured electrode member and an electrode extension member spaced from and spaced centrally of said annular configured electrode member.

4. A hair grooming device according to claim 1, wherein said ultrasonic wave generator comprises at least one ultrasonic transducer mounted at the hair engaging section that emits ultrasonic waves.

5. A hair grooming device according to claim 4, wherein said ultrasonic transducer comprises a planar shaped transducer mounted at said hair engaging section.

6. A hair grooming device according to claim 1, wherein said hair engaging section includes at least one ultrasonic wave vent to allow ultrasonic waves to pass.

7. A hair grooming device according to claim 1, wherein said casing includes a battery compartment for holding a battery that operatively connects to said voltage generator.

8. A hair grooming device comprising:
a casing having a handle section adapted to be grasped by hand, and a hair engaging section and respective planar attachment surface on which hair grooming tools are attached,
a voltage generator contained within said casing;
an electrode assembly mounted within said hair engaging section and operatively connected to said voltage generator for generating oxidized and ionized air onto hair to be groomed; and
an ultrasonic wave generator mounted within said hair engaging section and operatively connected to said voltage generator for generating ultrasonic waves onto hair for repelling fleas.

9. A hair grooming device according to claim 8, wherein said electrode assembly comprises a substantially annular configured electrode member and an electrode extension member spaced from and spaced centrally of said annular configured electrode member.

10. A hair grooming device according to claim 8, wherein said ultrasonic wave generator comprises at least one ultrasonic transducer mounted at the hair engaging section that emits ultrasonic waves.

11. A hair grooming device according to claim 10, wherein said ultrasonic transducer comprises a planar shaped transducer mounted at said hair engaging section.

12. A hair grooming device according to claim 8, wherein said hair engaging section includes at least one ionized air vent formed therein to allow ionized and oxidized air to be emitted and at least one ultrasonic wave vent to allow ultrasonic waves to pass.

13. A hair grooming device according to claim 8, wherein said casing includes a battery compartment for holding a battery that operatively connects to said voltage generator.

14. A hair grooming device comprising:
a casing having a handle section adapted to be grasped by hand and a hair engaging section, including an upper casing member and lower casing member, a planar attachment surface formed on the lower casing member on which hair grooming tools are attached;
a high voltage generator contained within said casing;
an electrode assembly mounted within said hair engaging section and operatively connected to said high voltage generator for generating oxidized and ionized air onto hair to be groomed; and
at least one ultrasonic transducer mounted on the lower casing member within said hair engaging section and operatively connected to said high voltage generator for generating ultrasonic waves onto hair for repelling fleas.

15. A hair grooming device according to claim 14, wherein said high voltage generator is carried by said upper casing member.

16. A hair grooming device according to claim 14, and further comprising an ionization channel formed within said lower casing member in a central portion thereof and extending in a direction longitudinally of said casing, wherein said electrode assembly is mounted therein.

17. A hair grooming device according to claim 14, and further comprising at least one ultrasonic transducer mounted on either side of said ionization channel.

18. A hair grooming device according to claim 14, wherein said high voltage generator is operative for generating a voltage of about 6,500 to about 7,500 volts.

19. A hair grooming device according to claim 14, wherein said electrode assembly comprises a substantially annular configured electrode member and an electrode extension member spaced from and spaced centrally of said annular configured electrode member.

20. A hair grooming device according to claim 14, wherein said ultrasonic wave generator comprises at least one ultrasonic transducer mounted at the hair engaging section that emits ultrasonic waves.

21. A hair grooming device according to claim 14, wherein said ultrasonic transducer comprises a planar shaped transducer mounted at said hair engaging section.

22. A hair grooming device according to claim 14, wherein said hair engaging section includes at least one ionized air vent formed therein to allow ionized and oxidized air to be emitted and at least one ultrasonic wave air vent to allow ultrasonic waves to pass.

23. A hair grooming device according to claim 14, wherein said casing includes a battery compartment for holding a battery that operatively connects to said voltage generator.
